(19) United States
(12) Patent Application Publication
(10) Pub. No.: US 2003/0143056 A1
(43) Pub. Date: Jul. 31, 2003

(54) Method of coupling sheet metal member and synthetic resin plate member, and structure coupled by this coupling method

(76) Inventor: Kazunobu Miura, Tokyo (JP)

Correspondence Address: Cameron Kerrigan, Squire, Sanders & Dempsey L.L.P., One Maritime Plaza, Suite 300, San Francisco, CA, 94111, US

(21) Appl. No.: 10/346,624

(22) Filed: Jan. 16, 2003

(30) Foreign Application Priority Data
Jan. 30, 2002 (JP) 2002-021385

(51) Int. Cl. F16B 25/00

(52) U.S. Cl. 411/386

(57) ABSTRACT

This invention relates to a method of coupling a sheet metal member and a synthetic resin plate member to each other, and a structure coupled by this coupling method. This coupling method includes the steps of forming a plurality of burring holes in the sheet metal member, which is to be coupled to a synthetic resin plate member having a plurality of prepared holes for self tapping screw insertion, by subjecting the sheet metal member to a burring process from the side of its coupling surface, positioning the coupling surface of the sheet metal member on the synthetic resin plate member such that the plurality of burring holes correspond to the plurality of prepared holes, respectively, and screwing self tapping screws in the plurality of burring holes and the plurality of prepared holes from the burring portion side.

### BACKGROUND OF THE INVENTION

1. Field of the Invention

The present invention relates to a method of coupling a sheet metal member and a synthetic resin plate member, and a structure coupled by this coupling method and, more particularly, to a door structure which is opened and closed often and which does not cause distortion easily after assembly.

2. Description of the Prior Art

Conventionally, when a self tapping screw such as a B tight type self tapping screw 224D as shown in FIG. 1 is clamped in a state as shown in FIG. 3, the screw slips or loosens often due to an external force or vibration. In particular, when a sheet metal member 221 is to be coupled to a synthetic resin plate member 241 by using the B tight type self tapping screw 224D, as the synthetic resin plate member 241 is softer than the sheet metal member 221, when the clamping torque of the screw is increased to be equal to or exceed a predetermined value, deformation of the thread groove (so-called over-screwing) occurs in the synthetic resin plate member 241. This hinders coupling of the synthetic resin plate member 241 and sheet metal member 221. As shown in FIG. 2, as the B tight type self tapping screw 224D has a flat head bearing surface 224a, the screw cannot be prevented loosening.

In a structure, e.g., a door, which is coupled in this state, the whole structure is twisted due to the loosening or slipping of the self tapping screw described above, and inconveniences occur, e.g., the opening/closing operation or the closed state of the door becomes incomplete.

In order to cope with this, conventionally, after the screw is clamped, it is fixed with a screw locking agent 224b (see FIG. 3), or a spring washer or a toothed washer 224c is inserted between the head bearing surface of the screw and the outer surface of the sheet metal member 221 (see FIG. 4).

These countermeasures, however, do not provide a sufficient strength against slipping or loosening of the screw, and increase the number of assembling steps, leading to a high cost, so they are not accordingly preferable in terms of the production.

### SUMMARY OF THE INVENTION

The present invention has been made in order to solve the above problems of the prior art, and has as its object to establish a simple and reliable method of coupling a sheet metal member to a synthetic resin plate member, and to provide a structure coupled by this coupling method.

In order to achieve the above object, according to the first aspect of the present invention, there is provided a method of coupling a sheet metal member and a synthetic resin plate member, comprising the steps of forming a plurality of burring holes in a sheet metal member, which is to be coupled to a synthetic resin plate member having a plurality of prepared holes for self tapping screw insertion, by subjecting the sheet metal member to a burring process from the side of a coupling surface thereof, such that a plurality of burring portions are formed on that surface of the sheet metal member which is opposite to the coupling surface, positioning the coupling surface of the sheet metal member on the synthetic resin plate member such that the plurality of burring holes correspond to the plurality of prepared holes, respectively, and screwing self tapping screws in the plurality of burring holes and the plurality of prepared holes from the side of the burring portions, respectively.

In order to achieve the above object, according to the second aspect of the present invention, there is provided a structure comprising a synthetic resin plate member having a plurality of prepared holes for self tapping screw insertion, at least one stay plate serving as a sheet metal member to be coupled to the synthetic resin plate member, the stay plate having a plurality of burring holes formed by subjecting the stay plate to a burring process from the side of a coupling surface thereof to be coupled to the synthetic resin plate member, such that a plurality of burring portions are formed on that surface of the sheet metal member which is opposite to the coupling surface, and being positioned on the synthetic resin plate such that the plurality of burring holes correspond to the plurality of prepared holes, respectively, and self tapping screws screwed in the plurality of burring holes and the plurality of prepared holes, respectively, from the side of the surface opposite to the coupling surface.

In order to achieve the above object, according to the third aspect of the present invention, there is provided a door structure for an image forming apparatus, comprising a synthetic resin plate member having a plurality of prepared holes for self tapping screw insertion, a pair of left and right stay plates serving as sheet metal members to be coupled to the synthetic resin plate member, the stay plates having a plurality of burring holes formed by subjecting the stay plates to a burring process from the side of coupling surfaces thereof to be connected to the synthetic resin plate member, such that a plurality of burring portions are formed on those surfaces of the stay plates which are opposite to the coupling surfaces, and being positioned on the synthetic resin plate such that the plurality of burring holes correspond to the plurality of prepared holes, respectively, a locking fixture provided to one of the pair of stay plates so as to be caught by and removed from a latch, fixed to a main body of the image forming apparatus, when opening or closing the door structure, a handle formed on one of the pair of stay plates so that the locking fixture is caught by and removed from the latch, a support fixture formed on the other one of the pair of stay plates and rotatably engaged with a fixing table, fixed to the main body of the image forming apparatus, through a hinge pin, and self tapping screws screwed in the plurality of burring holes and the plurality of prepared holes, respectively, from the side of the surface opposite to the coupling surface.

In the first to third aspects, the self tapping screws are B tight type self tapping screws, and the screws are screwed into the burring holes and the prepared holes, with head bearing surfaces thereof abutting against the burring portions, until a clamping torque reaches a predetermined value.

The predetermined value of the clamping torque is 0.5 N·m to 0.7 N·m when the self tapping screws are B tight type self tapping screws.

As is apparent from the aspects described above, according to the present invention, for example, a displacement due to screw slipping or loosening will not occur in the coupling portion of a convey door as the door structure of an image forming apparatus, and the convey door will not accordingly lose its rigidity to cause distortion. Therefore, troubles that can conventionally occur easily, e.g., abnormality in the opening/closing operation due to the deformation of the door structure, incomplete closing state, or defective conveyance of the transfer medium, are completely eliminated. Since the coupling method is simple and reliable, and the structure is coupled by this coupling method, the manufacturing cost can be largely reduced.

The above and many other objects, features and advantages of the present invention will become manifest to those skilled in the art upon making reference to the following detailed description and accompanying drawings in which a preferred embodiment incorporating the principle of the present invention is shown by way of an illustrative example.

### BRIEF DESCRIPTION OF THE DRAWINGS

FIG. 1 is schematic front views showing a B tight type self tapping screw;

FIGS. 2 to 4 are sectional views each showing the main part showing the conventional coupling state of a sheet metal member and synthetic resin plate member;

FIG. 5 is a sectional view of the main part showing the coupling state of a sheet metal member and synthetic resin plate member according to the present invention;

FIG. 6 is a schematic front view of a digital image forming apparatus on which a convey door as a door structure of the present invention is mounted;

FIG. 7 is a schematic side view of the digital image forming apparatus on which the convey door as the door structure of the present invention is mounted; and

FIG. 8 is a cross-sectional view showing an arrangement of the door structure according to the present invention.

### DETAILED DESCRIPTION OF THE PREFERRED EMBODIMENT

A preferred embodiment of the present invention will be described in detail with reference to the accompanying drawings. The following description does not limit the technical scopes of the respective claims or the meanings of the technical terms. The detailed description in the embodiment of the present invention shows the best mode and does not limit the technical scope of the present invention or the meanings of the technical terms.

A method of coupling a sheet metal member and synthetic resin plate member according to the present invention will be described with reference to FIG. 5.

First, a sheet metal member 221, which is to be coupled to a synthetic resin plate member 241 having a plurality of prepared holes 241a for self tapping screw insertion, is subjected to a burring process from its coupling surface, so as to form a plurality of burring holes 223a in the sheet metal member 221, such that a plurality of burring portions 223 are formed on that surface of the sheet metal member 221 which is opposite to the coupling surface.

Subsequently, the coupling surface of the sheet metal member 221 is positioned on the synthetic resin plate member 241, such that the plurality of burring holes 223a formed in the sheet metal member 221 correspond to the plurality of prepared holes 241a formed in the synthetic resin plate member 241, respectively.

Then, self tapping screws 224 are screwed into the plurality of burring holes 223a and the plurality of prepared holes 241a, respectively, from the side of the burring portions 223, with their toothed washers 224c abutting against the burring portions 223, until the clamping torque reaches a predetermined value.

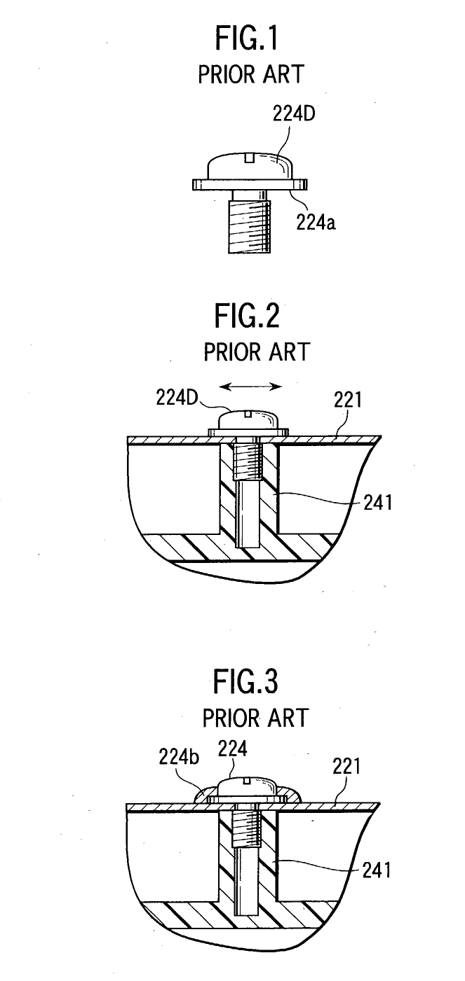

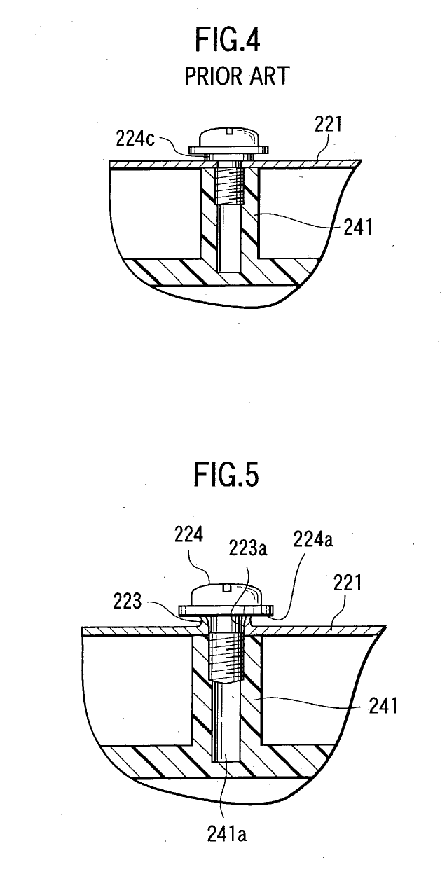

In this case, the predetermined value of the clamping torque is preferably 0.5 N·m to 0.7 N·m in the case of the B tight type self tapping screw 224D shown in FIG. 1.

As a structure, e.g., a door structure, assembled by this coupling method, a convey door used in an image forming apparatus such as a copying machine will be described.

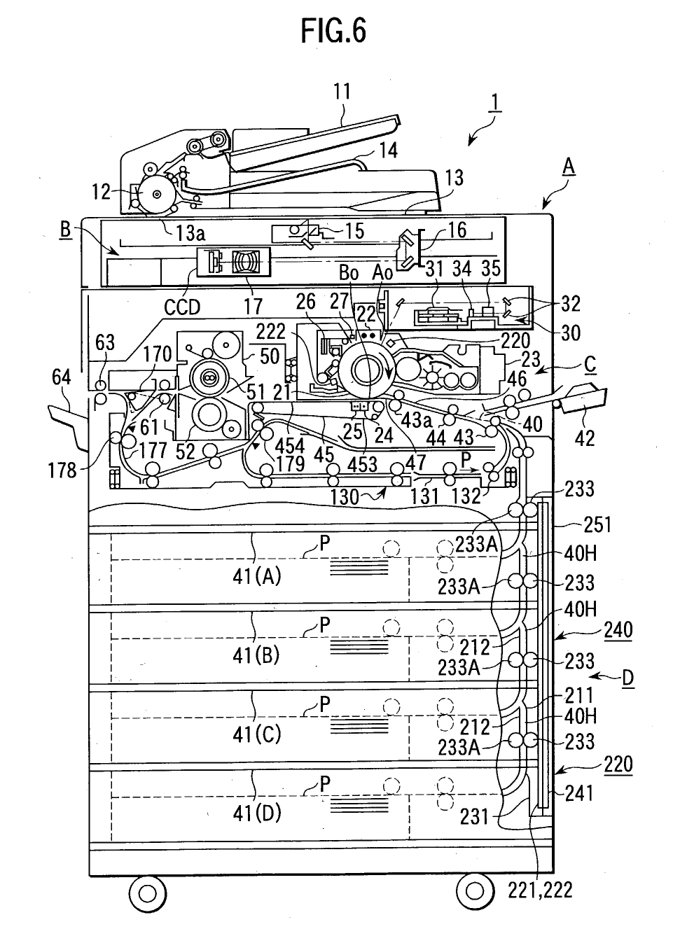

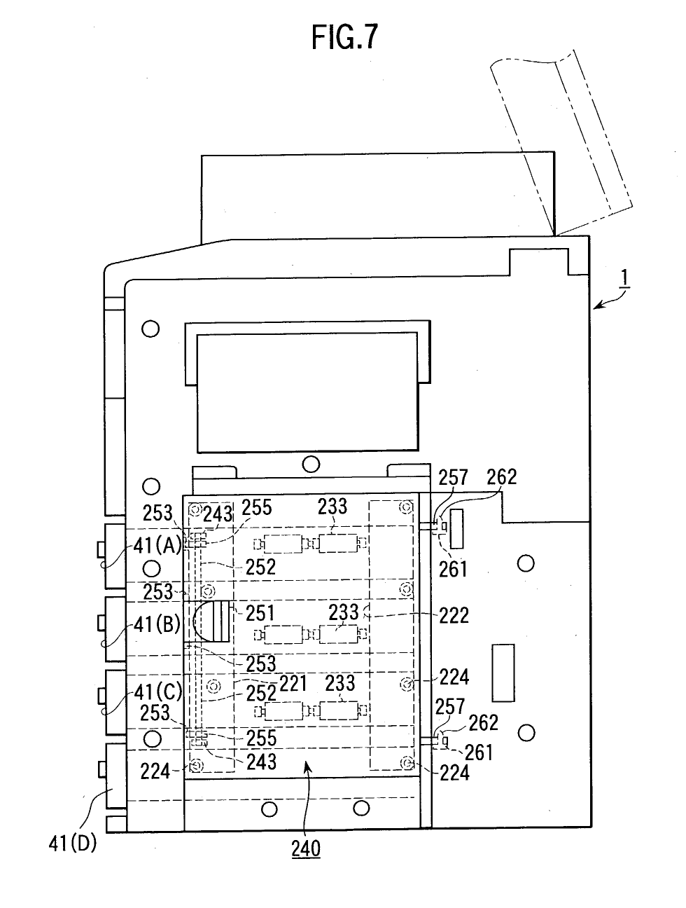

An image forming apparatus 1 shown in FIGS. 6 and 7 is a digital image forming apparatus on which a convey door 240 as a door structure according to the present invention is mounted. The image forming apparatus 1 is comprised of an image reading section A, an image processing section B, an image forming section C, and a transfer medium conveying section D as a transfer medium conveying means.

An automatic document feeding means which conveys a document automatically is formed above the image reading section A. Documents placed on a document table 11 are separated and conveyed one by one by document convey rollers 12, and the image of each document is read at a reading position 13a. The document that has been read is delivered by the document convey rollers 12 onto a document delivery tray 14.

When a document is placed on a platen glass plate 13, its image is read by the reading operation at a velocity v of a first mirror unit 15 comprised of an illumination lamp and a first mirror lamp that constitute a scanning optical system, and the movement at a velocity v/2 in the same direction of a second mirror unit 16 comprised of second and third mirrors that are positioned to form a letter V.

The read image is formed on the light-receiving surface of an imaging element CCD as a line sensor through a projection lens 17. The linear optical image formed on the imaging element CCD is sequentially photoelectrically converted into electrical signals (brightness signals). The electrical signals are then A/D-converted, and are processed by the image processing section B in accordance with density conversion, filtration, and the like. Then, the image data is temporarily stored in a memory.

The image forming section C as an image formation unit has a drum-like photosensitive body 21 serving as an image carrier. A charging means 22 for charging the photosensitive body 21, a potential detecting means 220 for detecting the surface potential of the charged photosensitive body 21, a developing means 23, a transfer convey belt unit 45 as a transfer means, a cleaning unit 26 for the photosensitive body 21, and a PCL (Pre-Charge Lamp) 27 as the optical charge removal means are arranged around the photosensitive body 21 in the order of operations. A reflection density detecting means 222 for measuring the reflection density of a patch image developed on the photosensitive body 21 is arranged downstream of the developing means 23. The photosensitive body 21 is formed by applying a photoconductive compound on a drum base. For example, an organic photosensitive body (OPC) is preferably used as the photosensitive body 21. The photosensitive body 21 is driven to rotate clockwise in FIG. 6.

The rotatable photosensitive body 21 is uniformly charged by the charging means 22, and is subjected to image exposure, on the basis of image signals read from the memory of the image processing section B, by an exposure optical system 30 serving as an image exposing means. The exposure optical system 30 as the image exposing means, which is a writing means has a laser diode (not shown) as an emission light source. A laser beam passes through a rotating polygon mirror 31, f−θ lens 34, and cylindrical lens 35, and its optical path is bent by a reflection mirror 32, so that main scanning is performed. Image exposure for the photosensitive body 21 is performed at a position Ao. The photosensitive body 21 then rotates (subscanning) to form a latent image. According to an example of this embodiment, the text portion is exposed to form a latent image.

The latent image on the photosensitive body 21 is reversed by the developing means 23, so that a visible toner image is formed on the surface of the photosensitive body 21. In the transfer medium conveying section D, sheet feed units 41(A), 41(B), 41(C), and 41(D) as transfer medium storing means which store transfer media P of different sizes are arranged below the image formation unit. A manual sheet feed unit 42 which allows manual sheet feeding is provided on a side of the transfer medium conveying section D. The transfer medium P supplied from the sheet feed unit 41(A), 41(B), 41(C), or 41(D) passes through guide rollers 233 and 233A that form a roller pair, and a vertical convey path 40H. The transfer medium P is then fed by guide rollers 43 along a convey path 40. The transfer medium P is temporarily stopped by a registration roller pair 44 that corrects any skew and shift of the transfer medium P which is being fed, and is fed again. The transfer medium P is guided by the convey path 40, pre-transfer rollers 43a, a sheet path 46, and an approach guide plate 47. The toner image on the photosensitive body 21 is transferred onto the transfer medium P at a transfer position Bo by a transfer electrode 24 and separation electrode 25 as it is placed on and conveyed by a transfer convey belt 454 of the transfer convey belt unit 45. The transfer medium P is separated from the surface of the photosensitive body 21, and is conveyed to a fixing means 50 by the transfer convey belt unit 45.

The fixing means 50 has a fixing roller 51 and press roller 52. When the transfer medium P is passed between the fixing roller 51 and press roller 52, the toner is fixed by heat and pressure. The transfer medium P on which the toner image has been fixed is delivered onto a delivery tray 64.

So far how to form an image on one side of the transfer medium P has been described. In the case of double-sided copy, a delivery switching member 170 switches, so that a sheet guide section 177 is opened, and the transfer medium P is conveyed in the direction of broken arrow.

Furthermore, the transfer medium P is conveyed downward by a convey mechanism 178, and is switched back by a sheet reversing section 179, so that its trailing end becomes the leading end. The transfer medium P is then conveyed into a double-sided copy sheet feed unit 130.

The transfer medium P moves on a convey guide 131 formed in the double-sided copy sheet feed unit 130 in the feeding direction. Sheet feed rollers 132 feed the transfer medium P again, and guide it to the convey path 40.

The transfer medium P is conveyed again toward the photosensitive body 21, as described above. The toner image is transferred to the lower surface of the transfer medium P, and is fixed by the fixing means 50. After that, the transfer medium P is delivered onto the delivery tray 64.

In this manner, the sheet feed unit is selected, and transfer media P of a necessary size are supplied one by one and conveyed through a considerably long distance. An image on the photosensitive drum is transferred and fixed onto each transfer medium P, so that single- or double-sided image formation is performed. Along the long convey path, the vertical convey paths 40H are formed immediately next to the outlets of the plurality of sheet feed units, respectively. These vertical convey paths 40H are formed on the right side wall in the front view of FIG. 6. A guide on one side of the vertical convey paths 40H employs a door structure, thus forming the convey door 240. The convey door 240 forms one side of the vertical convey paths 40H, that is, right-half convey guide surfaces 211 in FIG. 6. Left-half convey guides 212 are fixedly attached to the main body of the image forming apparatus 1. Each guide roller 233 is attached to a synthetic resin plate member 231 that forms the corresponding convey guide surface 211 on one side of the convey door 240. Each guide roller 233A which forms a pair with the corresponding guide roller 233 is fixedly attached, together with the corresponding left-half convey guide 212, to the main body of the image forming apparatus 1.

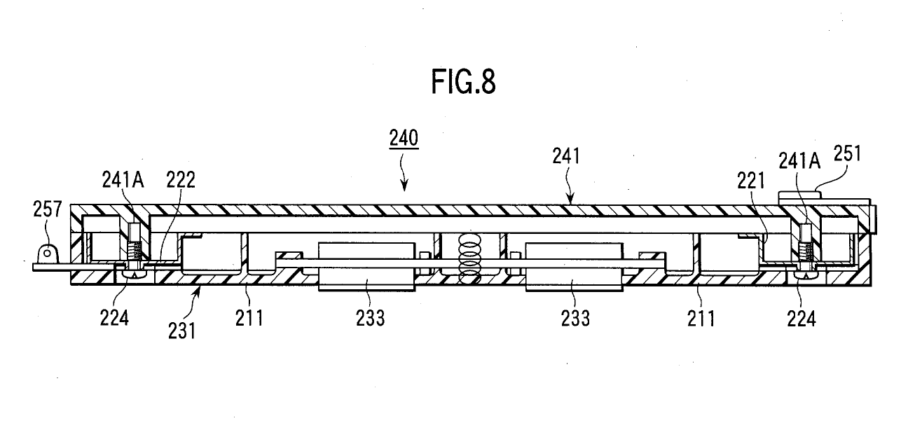

The convey door will be described with reference to FIG. 6 (front view), FIG. 7 (side view), and FIG. 8 (cross-sectional view).

The convey door 240 is a door structure which has a pair of left and right stay plates 221 and 222 as sheet metal members. Two synthetic resin plate members, e.g., the synthetic resin plate member 231 and a synthetic resin plate member 241, are coupled to the front and rear coupling surfaces of the stay plates 221 and 222.

Of the two synthetic resin plate members 231 and 241, one is the synthetic resin plate member 231 located inside the image forming apparatus 1 and having the function of guiding conveyance of the transfer medium P, and the other is the synthetic resin plate member 241 having the function of cladding the door.

One stay plate 221 has locking fixtures (hooks) 255 which are caught and removed, when the door is to be closed and opened, respectively, by and from latches 253 fixed to the main body of the image forming apparatus 1, and a handle 251 connected by a shaft 252 axially supported by bearings 243 and serving to catch and remove the locking fixtures 255. The other stay plate 222 has support fixtures 257 pivotally provided, through hinge pins 262, to two fixing tables 261 which are formed on the main body.

Each of the stay plates 221 and 222 is subjected to a burring process from its coupling surface side which is to be coupled to the synthetic resin plate member 241 having a plurality of prepared holes 241a for self tapping screw insertion and the function of cladding the door, so as to form the plurality of burring holes 223a, such that the plurality of burring portions 223 are formed on its side opposite to its coupling surface. The synthetic resin plate member 241 is positioned such that the plurality of prepared holes 241a correspond to the plurality of burring holes 223a, respectively. The self tapping screws 224 are inserted in the plurality of burring holes 223a and the plurality of prepared holes 241a, respectively, from the side of the burring portions 223. The self tapping screws 224 are then screwed, with their head bearing surfaces 224c abutting against the corresponding burring portions 223, until the clamping torque reaches a predetermined value in this state. Hence, the stay plates 221 and 222 and the synthetic resin plate member 241 are coupled to each other.

On the opposite side, through the pair of stay plates 221 and 222 as the sheet metal members, of the synthetic resin plate member 241 having the function of cladding the door, the other synthetic resin plate member 231, to which the convey guides 211 and guide rollers 233 are attached to serve as the convey guide for the transfer medium P, is coupled to the stay plates 221 and 222. The coupling method of the present invention is preferably applied to this coupling, but any conventional coupling method may be used as far as it is a firm one such as performing positioning with a knock pin.

With the convey door 240 having the above arrangement, even if some trouble occurs to the transfer medium P during its conveyance, it can be coped with appropriately by reliably opening the door. Cleaning and the like can also be performed easily. The interior of the image forming apparatus 1 excluding the convey path is opened largely. This is convenient for internal inspection, improving the workability when manufacturing the image forming apparatus 1.

As has been described above, with the convey door 240 as a structure which is coupled by the coupling method of the present invention, a displacement due to screw slipping or loosening will not occur in the coupling portion, and the convey door will not accordingly lose its rigidity to cause distortion. Therefore, troubles that can conventionally occur easily, e.g., abnormality in the opening/closing operation due to the deformation of the door structure, incomplete closing state, or defective conveyance of the transfer medium, are completely eliminated. Since the coupling method is simple and reliable, and the structure is coupled by this coupling method, the manufacturing cost can be largely reduced.

What is claimed is:

1. A method of coupling a sheet metal member and a synthetic resin plate member, comprising the steps of
forming a plurality of burring holes in a sheet metal member, which is to be coupled to a synthetic resin plate member having a plurality of prepared holes for self tapping screw insertion, by subjecting the sheet metal member to a burring process from the side of a coupling surface thereof, such that a plurality of burring portions are formed on that surface of the sheet metal member which is opposite to the coupling surface,
positioning the coupling surface of the sheet metal member on the synthetic resin plate member such that the plurality of burring holes correspond to the plurality of prepared holes, respectively, and
screwing self tapping screws in the plurality of burring holes and the plurality of prepared holes from the side of the burring portions, respectively.

2. A method according to claim 1, wherein the self tapping screws are B tight type self tapping screws, and the B tight type self tapping screws are screwed into the burring holes and the prepared holes, with head bearing surfaces thereof abutting against the burring portions, until a clamping torque reaches a predetermined value.

3. A method according to claim 2, wherein the predetermined value of the clamping torque is 0.5 N·m to 0.7 N·m.

4. A structure comprising
a synthetic resin plate member having a plurality of prepared holes for self tapping screw insertion,
at least one stay plate serving as a sheet metal member to be coupled to said synthetic resin plate member, said one stay plate having a plurality of burring holes formed by subjecting said stay plate to a burring process from the side of a coupling surface thereof to be coupled to said synthetic resin plate member, such that a plurality of burring portions are formed on that surface of said sheet metal member which is opposite to the coupling surface, and being positioned on said synthetic resin plate such that the plurality of burring holes correspond to the plurality of prepared holes, respectively, and
self tapping screws screwed in the plurality of burring holes and the plurality of prepared holes, respectively, from the side of the surface opposite to the coupling surface.

5. A structure according to claim 4, wherein said self tapping screws are B tight type self tapping screws, and said B tight type self tapping screws are screwed into the burring holes and the prepared holes, with head bearing surfaces thereof abutting against the burring portions, until a clamping torque reaches a predetermined value.

6. A door structure for an image forming apparatus, comprising
a synthetic resin plate member having a plurality of prepared holes for self tapping screw insertion,
a pair of left and right stay plates serving as sheet metal members to be coupled to the synthetic resin plate member, said stay plates having a plurality of burring holes formed by subjecting said stay plates to a burring process from the side of coupling surfaces thereof to be connected to said synthetic resin plate member, such that a plurality of burring portions are formed on those surfaces of said stay plates which are opposite to the coupling surfaces, and being positioned on said synthetic resin plate such that the plurality of burring holes correspond to the plurality of prepared holes, respectively,
a locking fixture provided to one of said pair of stay plates so as to be caught by and removed from a latch fixed to a main body of the image forming apparatus when opening or closing the door structure,
a handle formed on said one of said pair of stay plates so that said locking fixture is caught by and removed from said latch,
a support fixture formed on the other one of said pair of stay plates and rotatably engaged with a fixing table, fixed to the main body of the image forming apparatus, through a hinge pin, and
self tapping screws screwed in the plurality of burring holes and the plurality of prepared holes, respectively, from the side of the surface opposite to the coupling surface.

7. A door structure according to claim 6, wherein said self tapping screws are B tight type self tapping screws, and said B tight type self tapping screws are screwed into the burring holes and the prepared holes, with head bearing surfaces thereof abutting against the burring portions, until a clamping torque reaches a predetermined value.

8. A door structure according to claim 6, further comprising another synthetic resin plate member which has a predetermined functional portion and which is attached to an opposite side of said synthetic resin plate member through said pair of stay plates.
